(19) United States
(12) Patent Application Publication
(10) Pub. No.: US 2014/0118262 A1
(43) Pub. Date: May 1, 2014

(54) ELECTRONIC DEVICE

(71) Applicants: INVENTEC (PUDONG) TECHNOLOGY CORPORATION, Shanghai (CN); INVENTEC CORPORATION, Taipei (TW)

(72) Inventor: Chun-Chi Lin, Taipei (TW)

(73) Assignees: INVENTEC CORPORATION, Taipei (TW); Inventec (Pudong) Technology Corporation, Shanghai (CN)

(21) Appl. No.: 13/786,755

(22) Filed: Mar. 6, 2013

(30) Foreign Application Priority Data
Oct. 25, 2012 (CN) 201210412154.2

(51) Int. Cl. G09G 5/00; G06F 3/02

(52) U.S. Cl. CPC G09G 5/00; G06F 3/02
USPC 345/168; 345/1.3

(57) ABSTRACT

An electronic device includes a base, a frame and a display module. The base includes an input module. The frame is pivotally disposed on the base. The display module is disposed on the frame. The display module is unfolded or folded relative to the base through the frame. The display module includes a first display and a second display.

The second display is pivotally disposed on the first display and the second display has an unfolded position or a folded position relative to the first display.

### CROSS-REFERENCE TO RELATED APPLICATIONS

This non-provisional application claims priority under 35 U.S.C. §119(a) on Patent Application No(s). 201210412154.2 filed in China, P.R.C. on Oct. 25, 2012, the entire contents of which are hereby incorporated by reference.

### BACKGROUND

1. Technical Field

The disclosure relates to an electronic device, and more particularly to an electronic device having two displays.

2. Related Art

Computer has become an essential tool in everyday life as information technology evolves. The development of computer has progressed considerably, from desktop computer in the early stage to laptop nowadays, and the laptop has become popular among users.

Users are fond of laptop because of its characteristic of portability. Thus, users have developed different ways of using laptop. For example, two displays are often employed by users for increasing the work display area in order to enhance the work efficiency. Usually, users just add an additional monitor directly to satisfy such a requirement of usage. However, it is inconvenient for carrying around with an additional monitor. Moreover, carrying around with an additional monitor leads to a problem that the advantage of portability of laptop is lessened.

Therefore, a way to design an electronic device for solving the problem of the inconvenience for carrying around with a second monitor in conventional techniques has become an issue for designers.

### SUMMARY

The disclosure provides an electronic device comprising a base, a frame and a display module. The base comprises an input module. The frame is pivotally disposed on the base. The display module is disposed on the frame. The display module is unfolded or folded relative to the base through the frame. The display module comprises a first display and a second display. The second display is pivotally disposed on the first display and the second display has an unfolded position or a folded position relative to the first display.

### BRIEF DESCRIPTION OF THE DRAWINGS

The disclosure will become more fully understood from the detailed description given herein below for illustration only, and thus are not limitative of the disclosure, and wherein:

FIG. 1A is a perspective view of an electronic device according to one embodiment of the disclosure;

FIG. 1B is another perspective view of the electronic device in FIG. 1A;

FIG. 1C is another perspective view of the electronic device in FIG. 1A;

FIG. 1D is a partial enlarged perspective view of a first display, a second display and a connection rod in FIG. 1C;

FIGS. 2A to 2C are top views of a frame and a display module in FIG. 1A;

FIG. 3A is a back view of the electronic device of FIG. 1A; and

FIG. 3B is another back view of the electronic device of FIG. 1A.

### DETAILED DESCRIPTION

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications. The embodiments below are further used for explaining the disclosure rather than limiting the scope of the disclosure.

The wordings of first, second and third in the descriptions hereinafter are used for differentiating different elements, compositions and areas in the drawings. The wordings should not be construed as limitations to the elements, compositions and areas. In other words, without separating from the spirit and scope of the disclosure, a first element, a first composition and a first area described herein may also be a second element, a second composition and a second area.

The directional terms of upper, lower, left and right in the descriptions hereinafter are merely intended for explaining the relative relationships between various elements in the drawings. In other words, without separating from the spirit and scope of the disclosure, the descriptions of an element A disposed above an element B can also be explained as the element B disposed above the element A.

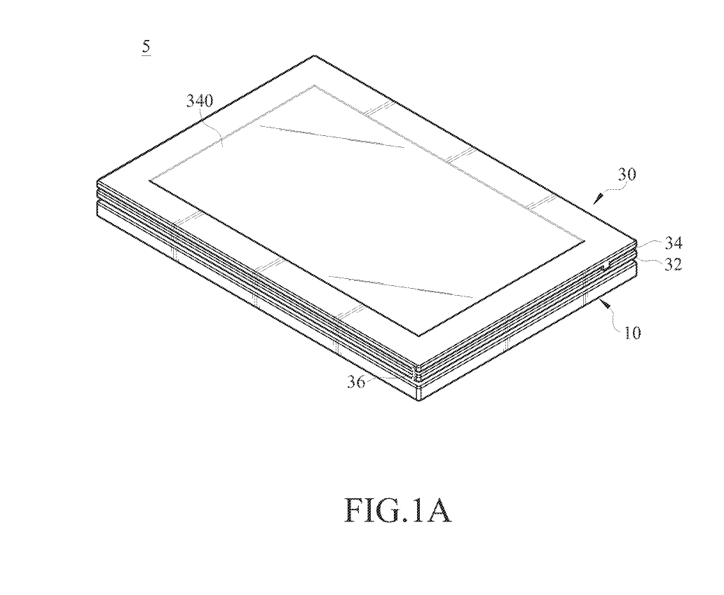

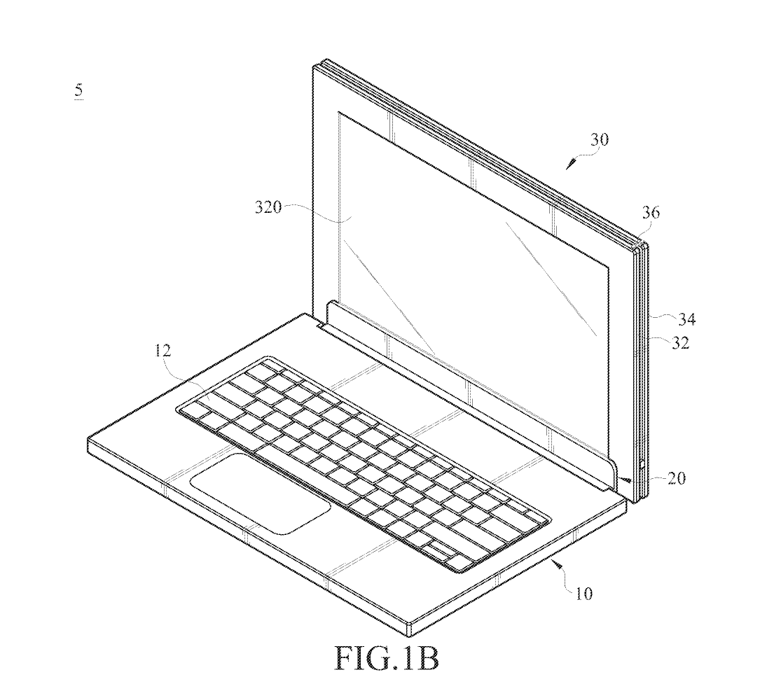

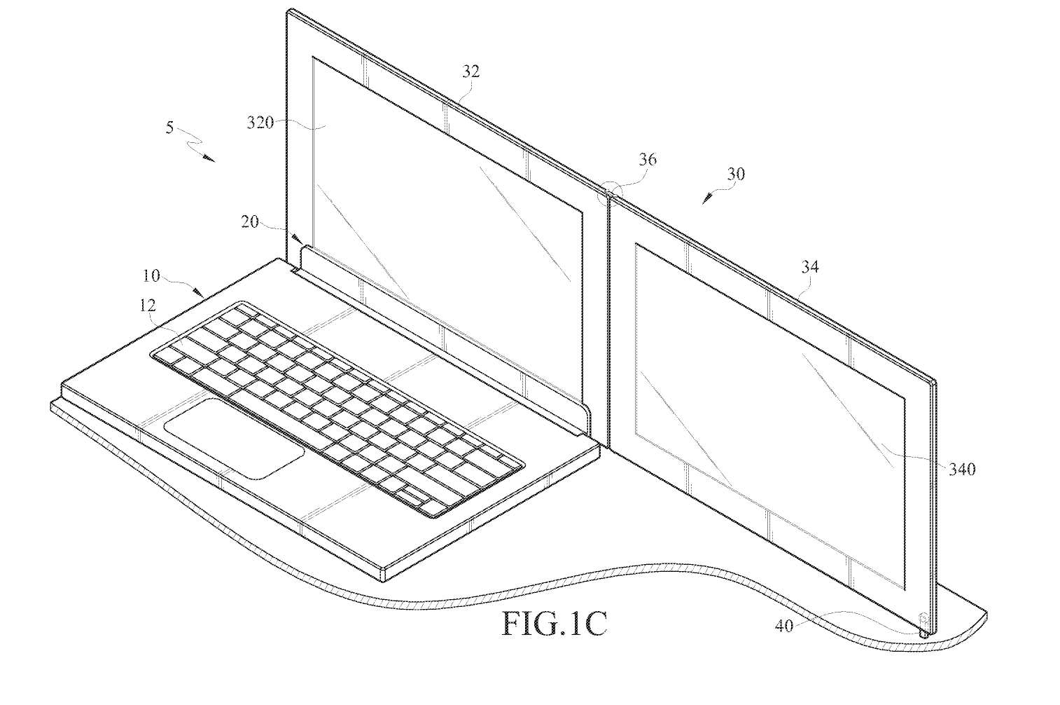

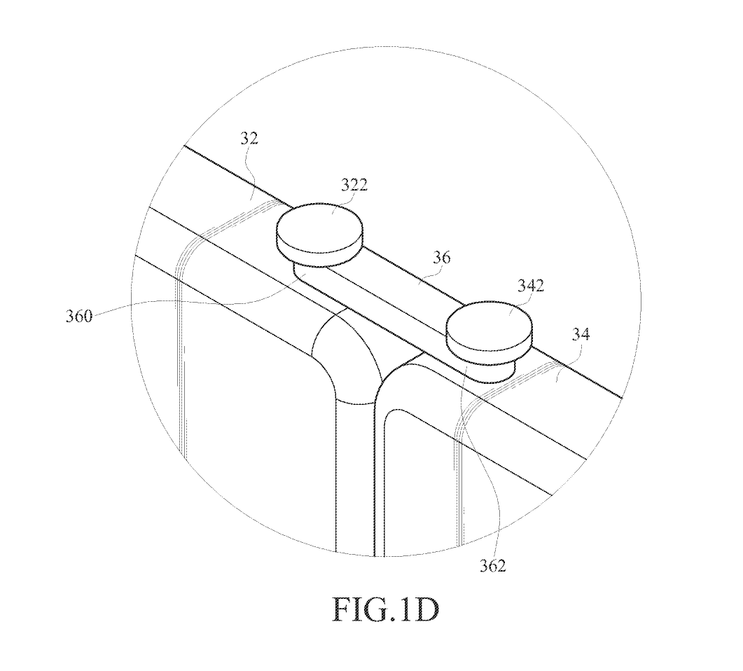

Please refer to FIGS. 1A to 1D. FIG. 1A is a perspective view of an electronic device according to one embodiment of the disclosure. FIGS. 1B and 1C are other perspective views of the electronic device in FIG. 1A. FIG. 1D is a partial enlarged perspective view of a first display, a second display and a connection rod in FIG. 1C.

An electronic device 5 comprises a base 10, a frame 20 and a display module 30. A laptop is used as example for the electronic device 5 in the descriptions hereinafter.

The base 10 comprises an input module 12. The input module 12, for example, is a keyboard, but not limited thereto. The frame 20 is pivotally disposed on the base 10. The display module 30 is disposed on the frame 20. Thereby, when the frame 20 is unfolded or folded relative to the base 10, the display module 30 is also unfolded or folded with the frame 20 relative to the base 10.

In this embodiment and other embodiments, the display module 30 comprises a first display 32 and a second display 34. The second display 34 is pivotally disposed on the first display 32, and the second display 34 has a folded position and an unfolded position relative to the first display 32. Specifically, in this embodiment and some other embodiments, the display module 30 further comprises a connection rod 36. The first display 32 comprises a first monitor 320 and a first pivot element 322. The second display 34 comprises a second monitor 340 and a second pivot element 342. The first pivot element 322 is disposed on the first display 32. The second pivot element 342 is disposed on the second display 34. The first pivot element 322 is pivotally connected to a first end 360 of the connection rod 36. The second pivot element 342 is pivotally connected to a second end 362 of the connection rod 36. Thereby, the second display 34 can be turned pivotally relative to the first display 32.

When a user only needs to use one monitor, the second display 34 is at the folded position, and the first monitor 320 and the second monitor 340 face oppositely. When the display module 30 is folded relative to the base 10, the first monitor 320 (not shown in the drawings) is disposed between the base 10 and the second monitor 340. Therefore, the user may operate the electronic device 5 in a way similar to a tablet computer by using the second monitor 340 as shown in FIG. 1A. When the display module 30 is unfolded relative to the base 10, the user may operate the electronic device 5 as a laptop by using the first monitor 320 as shown in FIG. 1B. When the user needs to use two monitors, the second display 34 is at the unfolded position, and the first monitor 320 and the second monitor 340 face toward the same direction as shown in FIG. 1C. In this embodiment and some other embodiments, the electronic device 5 further comprises a supporting leg 40.

The supporting leg 40 is disposed on the second display 34. For example, the supporting leg 40 may be pivotally connected on the second display 34. However, it should not be construed as a limitation to the disclosure. When the second display 34 is at the unfolded position, the supporting leg 40 can be turned outwardly relative to the second display 34 to support the second display 34 in order to enhance the stability of using the electronic device 5.

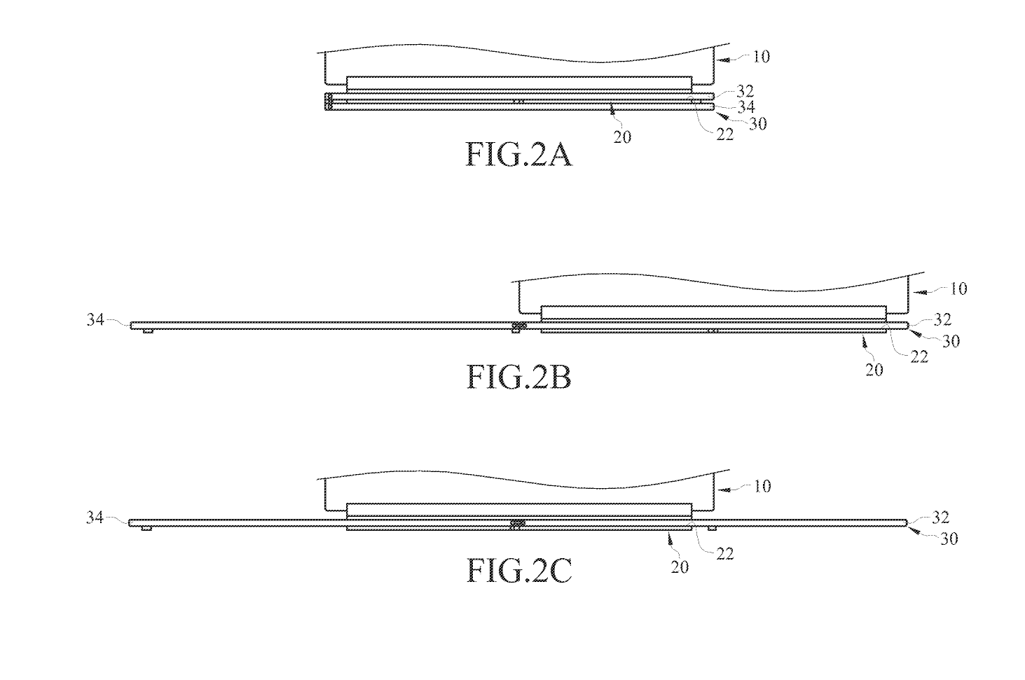

Please refer to FIGS. 1C and 2A to 2C. FIGS. 2A to 2C are top views of the frame and the display module in FIG. 1A. In this embodiment and some other embodiments, the frame 20 further comprises a slide groove 22. The first display 32 is movably disposed in the slide groove 22. Moving on the slide groove 22, the first display 32 has a first position and a second position relative to the slide groove 22. Specifically, when the second display 34 is turned pivotally relative to the first display 32 and disposed at the unfolded position, the first display 32 is moved by sliding relative to the slide groove 22. When the first display 32 is at the first position, the second display 34 is outside the slide groove 22 as shown in FIG. 2B. If the user needs the first display 32 and the second display 34 to be disposed at the center of visual angle, the first display 32 can be slid to the second position so that at least a part of the second display 34 is disposed inside the slide groove 22. Therefore, when the user uses the input module 12 of the base 10, the first display 32 and the second display 34 are at the center of visual angle as shown in FIG. 2C. Thereby, the user may adjust the positions of the first display 32 and the second display 34 relative to the slide groove 22 when different visual angles are required for viewing the electronic device 5.

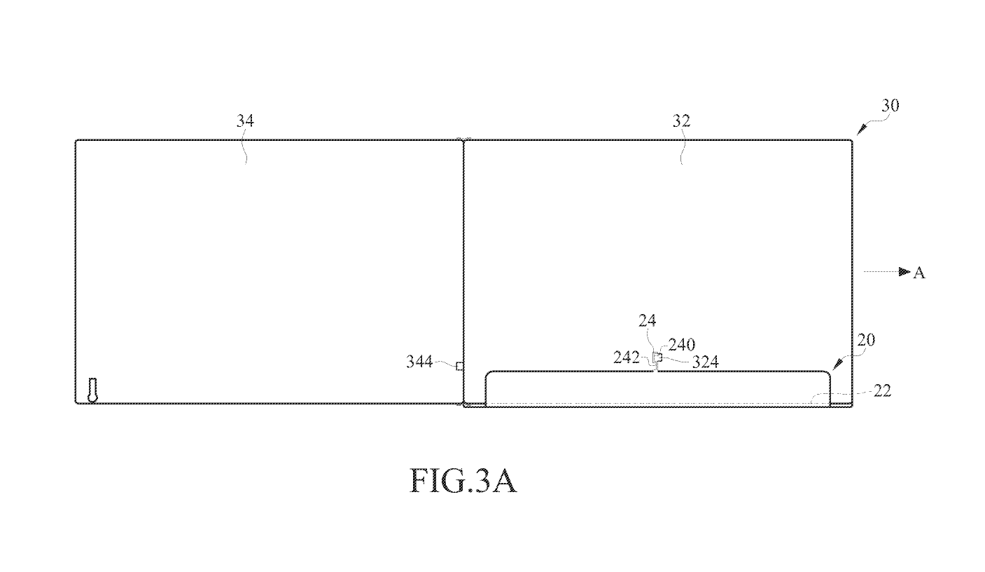

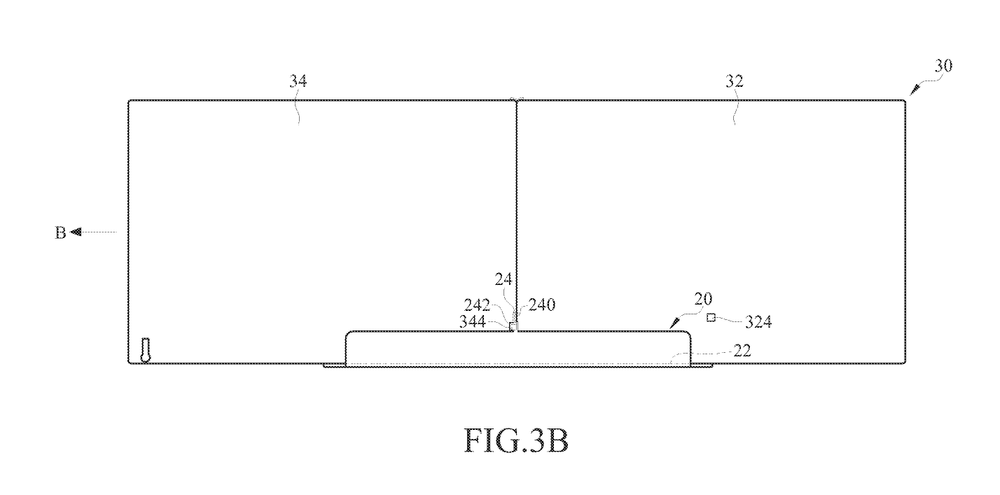

Please refer to FIGS. 3A and 3B. FIG. 3A is a back view of the electronic device of FIG. 1A; and FIG. 3B is another back view of the electronic device of FIG. 1A. In this embodiment and some other embodiments, in order to limit the sliding positions of the first display 32 and the second display 34 in the slide groove 22 as well as to prevent the first display 32 and the second display 34 from sliding outside the slide groove 22 to cause damage. The frame 20 further comprises a limiting structure 24, the first display 32 further comprises a first limiting block 324, and the second display 34 further comprises a second limiting block 344. Specifically, the limiting structure 24 has a first limiting groove 240 and a second limiting groove 242. The first limiting groove 240 and the second limiting groove 242 are disposed on two opposite sides of the limiting structure 24 respectively. The shape of the first limiting groove 240 matches that of the first limiting block 324, and the shape of the second limiting groove 242 matches that of the second limiting block 344.

When the first display 32 slides to the first position relative to the slide groove 22, the first limiting block 324 is pressed against and disposed in the first limiting groove 240 of the limiting structure 24. The second limiting block 344, meanwhile, is kept away from the limiting structure 24 at a distance. Thereby, the first display 32 and the second display 34 are limited to avoid moving toward a direction A, and the first display 32 is fixed at the first position as shown in FIG. 3A. When the second display 34 slides to the second position relative to the slide groove 22, the second limiting block 344 is pressed against and disposed in the second limiting groove 242 of the limiting structure 24. In addition, the first limiting block 324 is kept away from the limiting structure 24 at a distance. Thereby, the first display 32 and the second display 34 are limited to avoid moving toward a direction B, and the second display 34 is fixed at the second position as shown in FIG. 3B. Therefore, the first display 32 and the second display 34 are limited inside the slide groove 22, so as to prevent the first display 32 and the second display 34 from sliding outside the slide groove 22, and the first display 32 is fixed at the first position or the second display 34 is fixed at the second position.

According to the electronic device disclosed in the embodiment of the disclosure, the display module comprises the first display and the second display. Moreover, the second display is pivotally disposed on the first display. Therefore, the electronic device has two displays, and the design of pivotally disposing the second display on the first display is convenient for carrying around for users. Thereby, the problem of the inconvenience for carrying around with a second monitor additionally installed to a laptop in conventional techniques is solved.

Furthermore, in this embodiment and some other embodiments, the frame further comprises the limiting structure. The first display further comprises the first limiting block, and the second display further comprises the second limiting block. The first display and the second display are limited to move in the slide groove by the limiting structure. Moreover, the first display and the second display are prevented from sliding outside the slide groove to cause damage. Thereby, the safety is enhanced when using the electronic device.

Note that the specifications relating to the above embodiments should be construed as exemplary rather than as limitative of the invention, with many variations and modifications being readily attainable by a person of average skill in the art without departing from the spirit or scope thereof as defined by the appended claims and their legal equivalents.

What is claimed is:

1. An electronic device, comprising:
a base comprising an input module;
a frame pivotally disposed on the base; and
a display module disposed on the frame, the display module configured for being unfolded or folded relative to the base through the frame, the display module comprising a first display and a second display, the second display being pivotally disposed on the first display, and the second display having an unfolded position or a folded position relative to the first display.

2. The electronic device as claimed in claim 1, wherein the first display comprises a first monitor, the second display comprises a second monitor, when the second display is at the unfolded position, the first monitor and the second monitor face toward a same direction, and when the second display is at the folded position, the first monitor and the second monitor face oppositely.

3. The electronic device as claimed in claim 1, wherein the input module is a keyboard.

4. The electronic device as claimed in claim 1, further comprising a supporting leg disposed on the second display.

5. The electronic device as claimed in claim 1, wherein the frame further comprises a slide groove, and the first display is movably disposed in the slide groove.

6. The electronic device as claimed in claim 5, wherein the first display moving on the slide groove has a first position and a second position relative to the slide groove, the second display is outside the slide groove at the first position, at least a part of the second display is in the slide groove at the second position.

7. The electronic device as claimed in claim 6, wherein the frame further comprises a limiting structure, the first display further comprises a first limiting block, the second display further comprises a second limiting block, the first limiting block is pressed against the limiting structure at the first position, and the second limiting block is kept away from the limiting structure at a distance, the second limiting block is pressed against the limiting structure at the second position, and the first limiting block is kept away from the limiting structure at a distance.

8. The electronic device as claimed in claim 7, wherein the limiting structure has a first limiting groove and a second limiting groove, the first limiting groove and the second limiting groove are disposed on two opposite sides of the limiting structure respectively, the first limiting block is in the first limiting groove at the first position, and the second limiting block is in the second limiting groove at the second position.
